(19) United States
(12) Patent Application Publication
(10) Pub. No.: US 2014/0157144 A1
(43) Pub. Date: Jun. 5, 2014

(54) NETWORK SYSTEM

(71) Applicant: DeNA Co., Ltd., Tokyo (JP)

(72) Inventors: Sota MIZUSHIMA, Tokyo (JP); Kenichi Takahashi, Tokyo (JP); Hiroyuki Kawakami, Tokyo (JP)

(73) Assignee: DeNA Co., Ltd., Tokyo (JP)

(21) Appl. No.: 14/040,119

(22) Filed: Sep. 27, 2013

(30) Foreign Application Priority Data
Dec. 4, 2012 (JP) 2012-265624

(51) Int. Cl. G06F 3/0484

(52) U.S. Cl. CPC G06F 3/0484
USPC 715/744

(57) ABSTRACT

An object of the invention is to cause a user to efficiently create an application program on a web browser. A network system according to the invention includes: a service-provider server that provides a browser service capable of running in a web browser; a user terminal; and an application-creation support server. The application-creation support server automatically generates an application file by using an application-creation tool, the application file being for causing the browser service provided by the service-provider server to run in the application program. The application-creation support server changes a layout file included in the application file, based on an editing operation input by the user. The application-creation support server generates an executable file of the application program by packaging a plurality of files including the layout file that has been changed, based on the generated application file.

### CROSS-REFERENCE TO RELATED APPLICATIONS

The present application claims priority upon Japanese Patent Application No. 2012-265624 filed on Dec. 4, 2012 which is herein incorporated by reference.

### BACKGROUND

1. Technical Field

The invention relates to a network system.

2. Related Art

Known are network systems for causing users to create application programs on a web browser.

With this network system, though an application program can be created, for example, on a web browser, it is impossible to test the created application program. Therefore, in order to complete an application program, the use of other hardware/software tools is required. In other words, users need to take the time and effort to create an application program.

### SUMMARY

The present invention has been conceived in view of the above issue, and an object thereof is to cause a user to efficiently create an application program on a web browser.

An aspect of the present invention to solve the above and other problems is

an application-creation support server

that is communicably connected via network to a service-provider server and a user terminal and
the service-provider server providing a browser service capable of running in a web browser,
the user terminal being used by a user when the user creates an application program on a web browser,
the application-creation support server supporting the creation of the application program,

the application-creation support server including:

a storage unit that stores an application-creation tool used for the creation of the application program;

an application-generation unit that automatically generates an application file by using the application-creation tool and in response to a request from the user terminal,
the application file being for causing the browser service to run in the application program;

a screen-data generation unit that generates screen data in response to a request from the user terminal,
the screen data being for displaying a layout-editing screen on a web browser of the user terminal which has issued the request,
the layout-editing screen including
   a source code region in which a source code of a layout file included in the application file is displayed, and
   a preview region for testing a screen layout defined by the layout file;

a layout processing unit that changes the layout file based on an editing operation input by the user on the layout-editing screen; and

a packaging unit that generates an executable file of the application program by using the application-creation tool and in response to a request from the user terminal, based on the generated application file, the executable file in which a plurality of files including the layout file that has been changed are packaged.

Other features of the invention will become clear through the detailed description of the present invention and the accompanying drawings.

### BRIEF DESCRIPTION OF THE DRAWINGS

FIG. 1 is a diagram showing an example of the overall configuration of a network system 1.

FIG. 2 is a block diagram showing a functional configuration of an application-creation support server 10.

FIG. 3 is a diagram showing an example of a data structure of developer-user information.

FIG. 4 is a diagram showing an example of a data structure of application information.

FIG. 5 is a block diagram showing a functional configuration of a game server 20.

FIG. 6 is a block diagram showing a functional configuration of an intermediary server 30.

FIG. 7 is a block diagram showing a functional configuration of an application-provider server 40.

FIG. 8 is a block diagram showing a functional configuration of a developer-user terminal 50 and an end-user terminal 60.

FIG. 9 is a flowchart illustrating an operation example of the application-creation support server 10.

FIG. 10 is a diagram showing an example of the appearance of a layout-editing screen 90.

FIG. 11 is a flowchart illustrating a packaging process.

### DETAILED DESCRIPTION OF THE INVENTION

With Detailed Description of the Invention and accompanied drawings, at least the following matters will be apparent.

An application-creation support server

that is communicably connected via network to a service-provider server and a user terminal and
the service-provider server providing a browser service capable of running in a web browser,
the user terminal being used by a user when the user creates an application program on a web browser,
the application-creation support server supporting the creation of the application program, the application-creation support server including:

a storage unit that stores an application-creation tool used for the creation of the application program;

an application-generation unit that automatically generates an application file by using the application-creation tool and in response to a request from the user terminal,
the application file being for causing the browser service to run in the application program;

a screen-data generation unit that generates screen data in response to a request from the user terminal,
the screen data being for displaying a layout-editing screen on a web browser of the user terminal which has issued the request,
the layout-editing screen including
   a source code region in which a source code of a layout file included in the application file is displayed, and
   a preview region for testing a screen layout defined by the layout file;

a layout processing unit that changes the layout file based on an editing operation input by the user on the layout-editing screen; and

a packaging unit that generates an executable file of the application program by using the application-creation tool and in response to a request from the user terminal, based on the generated application file, the executable file in which a plurality of files including the layout file that has been changed are packaged.

With such a server, it is possible to cause a user to efficiently create an application program on a web browser.

Further, in such an application-creation support server, it is acceptable that

the executable file of the application program contains a charging-and-payment API that is necessary for charging and payment in the application program.

With such a server, the charging-and-payment API that is necessary for charging and payment in the application program is automatically contained in the executable file of the application program. This makes it possible to reduce users' load associated with programming operations.

Further, in such an application-creation support server, it is acceptable that

the application-creation support server is communicably connected via the intermediary server to the service-provider server,

when generating the application file, the application-generation unit gives to the application file identification information for identifying the application program,

the packaging unit causes the executable file of the application program to contain the identification information given to the application program,

the intermediary server includes a storage unit that stores a service-provider server list,
the service-provider server list containing a URL of the service-provider server correlating to the identification information given to the application program.

With such a server, when executing the application program, a user terminal accesses the service-provider server through the intermediary server. This makes it impossible to identify the user terminal which has accessed the service-provider server, which enables to prevent unauthorized disclosure of users' personal information. Further, it is not necessary to change settings of the service-provider server in order to run existing browser services in the application program. It is sufficient to change settings of the intermediary server only.

Further, in such an application-creation support server, it is acceptable that

the application-creation support server further includes an emulator unit that performs a virtual execution of the browser service,
the browser service being provided by a service-provider server being accessed,
the virtual execution being performed by executing the application program and in response to a request from the user terminal,
the virtual execution being performed on the layout-editing screen displayed in a web browser of the user terminal which has issued the request.

With such a server, it is possible to test the application program on the layout-editing screen. This makes it possible to cause a user to efficiently create an application program on a web browser.

Further, a non-transitory storage medium that can be read by an application-creation support server, the storage medium having a program stored thereon, the program executed by the application-creation support server,

the application-creation support server being communicably connected via network to a service-provider server and a user terminal,

the application-creation support server supporting creation of the application program,

the service-provider server providing a browser service capable of running in a web browser,

the user terminal being used by a user when the user creates an application program on a web browser, the application-creation support server,

the program instructing the application-creation support server to perform the following processes:

a process in which an application-creation tool used for creation of the application program is stored in a storage unit;

an application-generation process in which application files for causing the browser service to run in the application program are automatically generated by using the application-creation tool and in response to a request from the user terminal;

a screen-data generation process in which screen data is generated in response to a request from the user terminal,
the screen data being for displaying a layout-editing screen on a web browser of the user terminal which has issued the request,
the layout-editing screen including
   a source code region in which a source code of a layout file included in the application files is displayed, and
   a preview region for testing a screen layout defined by the layout file;

a layout process in which the layout file is changed based on an editing operation input by the user on the layout-editing screen; and

a packaging process in which an executable file of the application program is generated by using the application-creation tool and in response to a request from the user terminal, based on the generated application files, the executable file in which a plurality of files including the layout file that has been changed are packaged.

With such a program, it is possible to cause a user to efficiently create an application program on a web browser.

Further, a network system including

an application-creation support server that is communicably connected to a service-provider server and a user terminal,

an intermediary server placed between the service-provider server and the application-creation support server,
the service-provider server that provides a browser service capable of running in a web browser,
the user terminal that is used by a user when the user creates an application program on a web browser,
the application-creation support server supporting creation of the application program,

the application-creation support server including:

a storage unit that stores an application-creation tool used for creation of the application program,

an application-generation unit
that automatically generates application files by using the application-creation tool and in response to a request from the user terminal, and
that, when generating the application files, gives identification information for identifying the application program,
   the application files being for causing the browser service provided by the service-provider server to run in the application program;

a screen-data generation unit that generates screen data in response to a request from the user terminal,
the screen data being for displaying a layout-editing screen on a web browser of the user terminal which has issued the request,
the layout-editing screen including
   a source code region in which a source code of a layout file included in the application files is displayed, and
   a preview region for testing a screen layout defined by the layout file;

a layout processing unit that changes the layout file based on an editing operation input by the user on the layout-editing screen; and

a packaging unit
that generates an executable file of the application program by using the application-creation tool and in response to a request from the user terminal, based on the generated application files, and
that causes the executable file of the application program to contain the identification information given to the application program,
   the executable file in which a plurality of files including the layout file that has been changed are packaged,

the intermediary server including:

a storage unit that stores a service-provider server list,
the service-provider server list containing a URL of the service-provider server correlating to the identification information given to the application program.

With such a network system, it is possible to cause a user to efficiently create an application program on a web browser. In addition, when executing the application program, a user terminal accesses the service-provider server through the intermediary server. This makes it impossible to identify the user terminal which has accessed the service-provider server, which enables to prevent unauthorized disclosure of users' personal information. Further, it is not necessary to change settings of the service-provider server in order to run existing browser services in the application program. It is sufficient to change settings of the intermediary server only.

### Embodiments

A network system 1 providing various services associated with application programs of games will be specifically described in the following embodiments as an example. However, the invention can be applied to Web services other than games, such as a social networking service or a messaging service.

Configuration of Network System 1

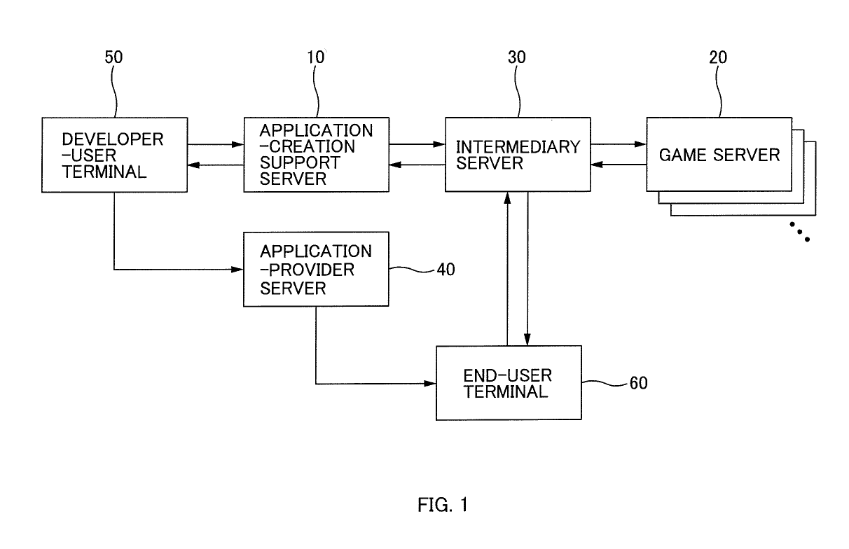

FIG. 1 is a diagram showing an example of the overall configuration of a network system 1 associated with the present embodiment. The network system 1 associated with the present embodiment includes: a application-creation support server 10; game servers 20, an example of service-provider server; a intermediary server 30; an application-provider server 40; a developer-user terminal 50; and an end-user terminal 60. These devices are connected via a network (i.e., the Internet)

The developer-user terminal 50 has a function of a web browser. If a user accesses the application-creation support server 10, the developer-user terminal 50 enables the user to perform various processes on a web browser such as creation or editing of application programs without installing dedicated software. In addition, if the developer-user terminal 50 accesses the game server 20 via the intermediary server 30, the developer-user terminal 50 can serve as an emulator that enables a virtual execution of a browser game which should run in an application program of the end-user terminal 60.

The application-creation support server 10 serves as an application-creation tool and can generate an application program which can be installed in the end-user terminal 60; the application-creation support server 10 performs the generating by automatically packaging a plurality of files necessary to run an application program created by a developer-user.

The application-provider server 40 publishes the application program generated by the application-creation support server 10, and provides the program to the end-user terminal 60 for free or at cost.

On the end-user terminal 60, an application program downloaded from the application-provider server 40 can run by installing the application program. Also, by running an application program, a user can access any of the game servers 20 on the end-user terminal 60 via the intermediary server 30 to run a browser game on the application program.

When the developer-user terminal 50 or the end-user terminal 60 sends a request to access a game server specified by an application program, the intermediary server 30 connects to an appropriated game server supporting the application program, and sends back game contents, which are acquired from the game server 20, to the end-user terminal 60 or the developer-user terminal 50 which has issued the request.

Configuration of Application-Creation Support Server 10

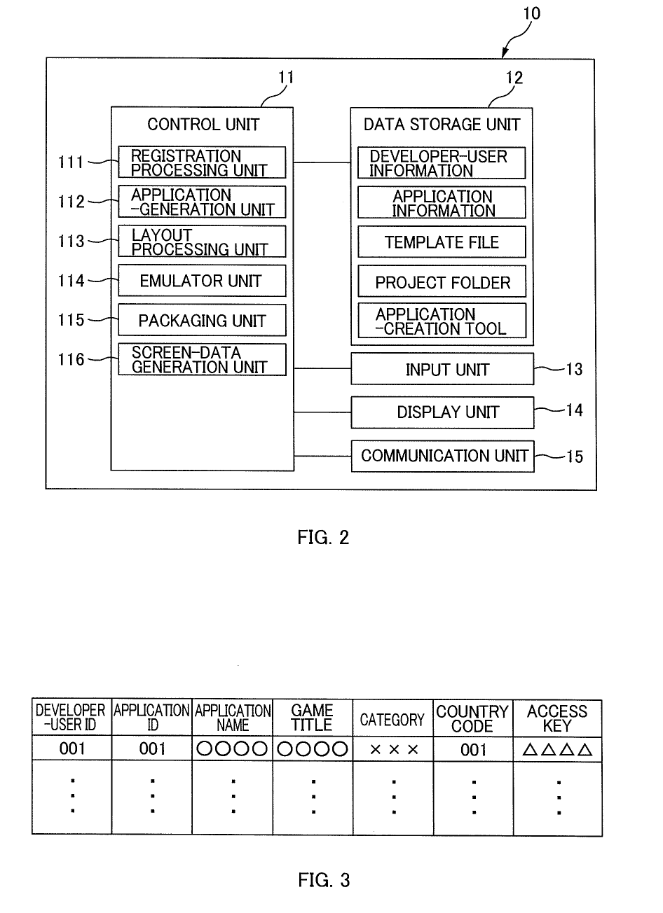

FIG. 2 is a block diagram showing a functional configuration of the application-creation support server 10 associated with the present embodiment. The application-creation support server 10 is an information processing device (i.e., work station or a personal computer) which supports creation of application programs with software development tools and the like. When receiving various commands (requests) from the developer-user terminal 50 used by a developer (developer-user), the application-creation support server 10 can transmit (respond) the following things: game programs capable of running on the developer-user terminal 50; a Web page (an operation screen, a game screen, etc.) described in markup language (XML, etc.) suited to the standards of the developer-user terminal 50. The application-creation support server 10 includes: a control unit 11; a data storage unit 12; an input unit 13; a display unit 14; and a communication unit 15.

The control unit 11 is a unit that transfers data among the units and controls the entire application-creation support server 10, and is realized by a central processing unit (CPU) executing a program stored in a certain memory. The control unit 11 according to the present embodiment includes a registration processing unit 111, an application-generation unit 112, a layout processing unit 113, an emulator unit 114, a packaging unit 115, and an image-data processing unit 116.

The registration processing unit 111 carries out, when creating a new application program, a process of storing in the data storage unit 12 registration information input by a developer-user on the developer-user terminal 50.

The application-generation unit 112 carries out a process of generating new application files (a project) by using application-creation tools. The application files (the project) is a set of files necessary to run the application program, such as setting file, program files and image files. The application files (the project) has a directory structure in which a plurality of folders and the like are in a hierarchy.

The layout processing unit 113 carries out a process for setting screen layouts of the application program.

The emulator unit 114 serves as an emulator that performs in the developer-user terminal 50 a virtual execution of an application program that should run on the end-user terminal 60 (an application program created by a developer-user).

The packaging unit 115 carries out a process for generating a package file (executable file) by using the application-creation tool, the package file being an assembly of a plurality of files (folders) necessary to run the application program.

The image-data processing unit 116 carries out a process for generating screen data to be displayed on a web browser. In the present embodiment, XML data and HTML data are generated as screen data corresponding to operation screens and the like.

The data storage unit 12 has a read only memory (ROM) and a random access memory (RAM): the ROM is a read-only storage region in which system programs are stored, and the RAM is a rewritable storage region in which various types of data are stored and which is used as a work area for computing processes performed by the control unit 11. The data storage unit 12 is realized, for example, by a non-volatile storage device such as a flash memory or a hard disk or by volatile storage device. The data storage unit 12 according to the present embodiment stores developer-user information, application information, a template file, a project folder, the application-creation tools and the like.

The developer-user information is registration information associated with a developer-user and consists of a developer-user ID, an application ID, an application name, a game title, a category, a country code, an access key and the like (see FIG. 3). The developer-user ID is identification information for identifying a developer-user. The application ID is identification information for identifying an application program created by a developer-user. The application name is information indicating display name of the application program. The game title is information indicating a display name of a game correlating to the application program. The category is information indicating a game genre to which the application program belongs. The country code is identification information for identifying each of the countries where the application program is released. The access key is security information that is necessary for accessing the intermediary server.

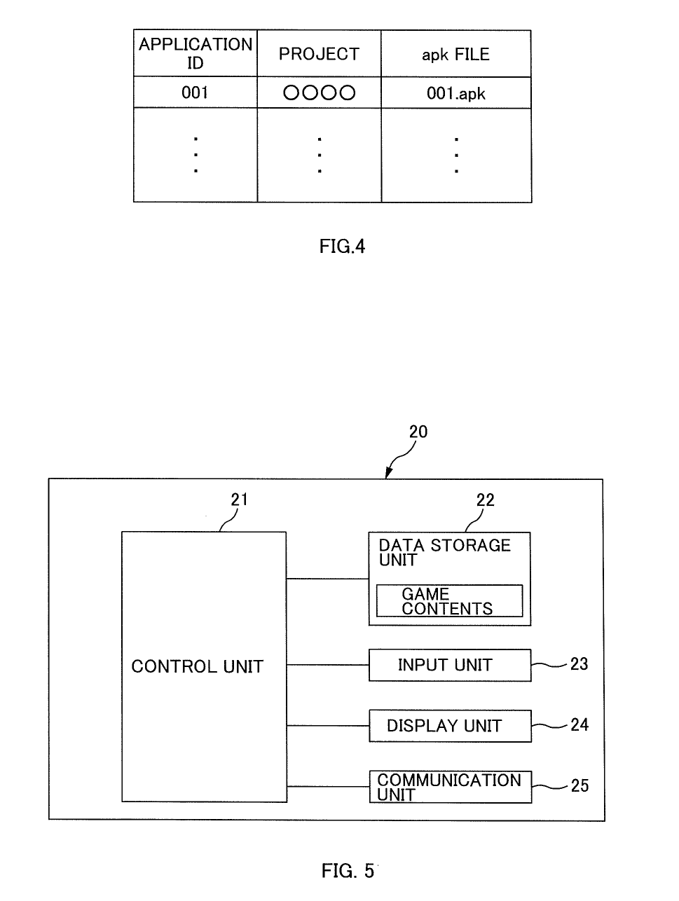

The application information is registration information associated with an application program, and consists of an application ID, a project, a package file and the like (see FIG. 4).

The template file is composed of a single file into which a plurality of files are compressed, and is a file in its initial state, which has not been edited by a developer-user.

The project folder is one which contains an application program project generated by the application-generation unit 112.

The application-creation tools are development tool required to create application programs, such as a software development kit (SDK), various types of templates (i.e., API) and the like.

The input unit 13 is one with which a system administrator, etc. input various types of data, and is realized, for example, by a keyboard, a mouse and the like.

The display unit 14 is for displaying operation screens for a system administrator according to commands from the control unit 11. The display unit 14 is realized, for example, by a liquid crystal display (LCD) and the like.

The communication unit 15 is for performing communication with external devices such as the developer-user terminal 50. The communication unit 15 has a function as a receiver for receiving signals and various types of data transmitted from the external devices and a function as a transmitter for transmitting signals or various types of data to the external devices according to commands from the control unit 11. communication unit 15 is realized, for example, by a network interface card (NIC) and the like.

Configuration of Game Server 20

FIG. 5 is a block diagram showing a functional configuration of the game servers 20 associated with the present embodiment. Each game server 20 is an information processing device (i.e., a work station or a personal computer) providing browser services (i.e., browser game) which run on a web browser and used by a system operator, a system administrator, or the like. When the game server 20, for example, receives various commands (requests) from the end-user terminal 60, the game server 20 enables a user to play a game on the end-user terminal 60 by transmitting a Web page for the game described in markup language (XML, etc.) suited to the standards of the end-user terminal 60. Each game server 20 includes a control unit 21, a data storage unit 22, an input unit 23, a display unit 24, and a communication unit 25.

The control unit 21 is a unit that transfers data among the units and controls the entire game server 20, and is realized by a central processing unit (CPU) executing a program stored in a certain memory.

The data storage unit 22 has a read only memory (ROM) and a random access memory (RAM): the ROM is a read-only storage region in which system programs are stored, and the RAM is a rewritable storage region in which various types of data are stored and which is used as a work area for computing processes performed by the control unit 21. The data storage unit 22 is realized, for example, by a non-volatile storage device such as a flash memory or a hard disk or by volatile storage device. The data storage unit 22 according to the present embodiment stores game contents that is necessary for causing browser games to run on a web browser or in an application program (the game contents mean document data, image data, audio data, user data, programs for controlling game progress and the like).

The input unit 23 is one with which a system administrator, etc. input various types of data, and is realized, for example, by a keyboard, a mouse and the like.

The display unit 24 is for displaying operation screens for a system administrator according to commands from the control unit 21. The display unit 24 is realized, for example, by a liquid crystal display (LCD) and the like.

The communication unit 25 serves as a receiver-transmitter unit for transmitting and receiving various information via network between an external device such as the application-creation support server 10, the intermediary server 30, or the user terminal 60. The communication unit 25 is realized, for example, by a network interface card (NIC) and the like.

Configuration of Intermediary Server 30

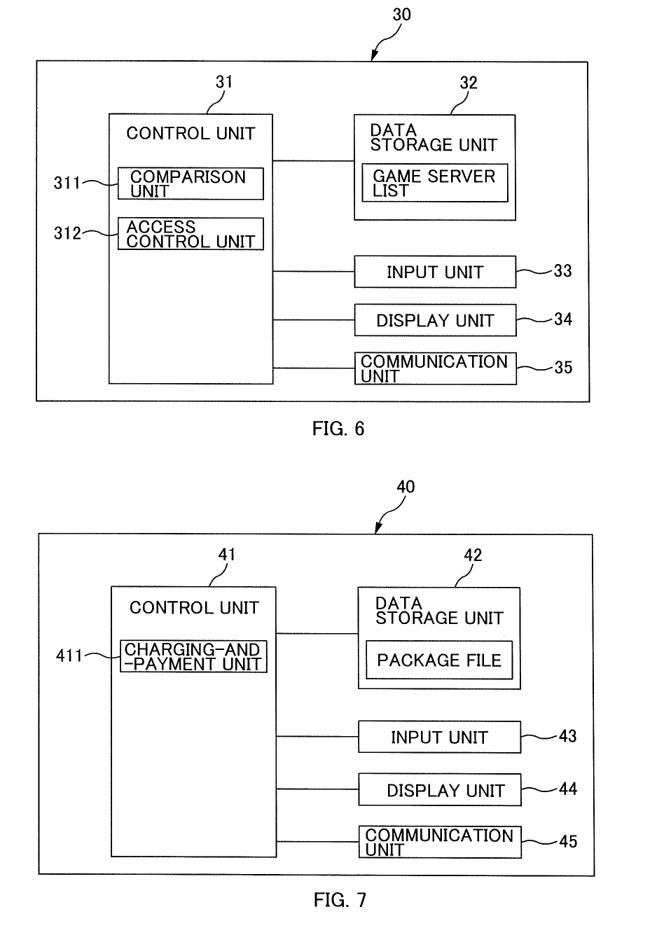

FIG. 6 is a block diagram showing a functional configuration of the intermediary server 30 associated with the present embodiment. The intermediary server 30 are placed between the application-creation support server 10 and the game servers 20, and between the game servers 20 and the end-user terminal 60. When the intermediary server 30 receives from the application-creation support server 10 or the user terminal 60 a request for accessing any of the game servers 20, the intermediary server 30 accesses the specified game server 20, instead of the application-creation support server 10 and the end-user terminal 60. Since this makes it impossible to identify the end-user terminal 60 that has accessed to the game server 20, it is possible to prevent unauthorized disclosure of end users' personal information (i.e. terminal ID). Also, if any change is made in a game server 20 (i.e. change of its address or internal configuration), that change of the game server 20 can be dealt with by changing settings of the intermediary server 30. This can reduce the number of times settings in the end-user terminal 60 are changed (i.e. updating application programs). That is, this can reduce users' loads associated with the foregoing change in the game server 20. In addition, placing the intermediary server 30 between the end-user terminal 60 and the game server 20 makes it possible to prevent illegal accesses from the end-user terminal 60 to the game server 20, which results in higher security level. The intermediary server 30 includes a control unit 31, a data storage unit 32, an input unit 33, a display unit 34, and a communication unit 35, in the same way as the game server 20.

The control unit 31 according to the present embodiment includes a comparison unit 311 and an access control unit 312. A function of the comparison unit 311 is to compare the following two URLs when receiving from the end-user terminal 60 a request for accessing to a URL: that URL; and a URL that is written in a game server list stored in the data storage unit 32. The access control unit 312 judges, based on the comparison result made by the comparison unit 311, whether or not the access request received from the end-user terminal 60 is a request for accessing the URL of any game server. Also, the access control unit 312 performs controlling an access to the URL designated by the request of the end-user terminal 60.

The data storage unit 32 according to the present embodiment stores a list of the game servers and the like. The game server list is data in which the URL of each game server correlates to an application ID for identifying an application program.

Configuration of Application-Provider Server 40

FIG. 7 is a block diagram showing a functional configuration of the application-provider server 40 associated with the present embodiment. The application-provider server 40 is an information processing device (i.e., a work station or a personal computer) used by a system operator, a system administrator etc. and providing executable files (i.e., apk files or app files) of an application program which can be installed in the end-user terminal 60. When receiving various commands (requests) from the end-user terminal 60, the application-provider server 40 can provide an end user with the application program by transmitting a Web page which is for purchasing and downloading application programs, the Web page being described in markup language (XML, etc.) suited to the standards of the end-user terminal 60. The application-provider server 40 includes a control unit 41, a data storage unit 42, an input unit 43, a display unit 44, and a communication unit 45, in the same way as the game server 20.

The control unit 41 according to the present embodiment includes a charging-and-payment unit 411. The charging-and-payment unit 411 is one that transmits and receives charging information between the application-provider server 40 and the end-user terminal 60 in which an application program is installed, thereby enabling the charging and payment in the application program. In this case, the end-user terminal 60 uses a charging-and-payment API included in the application program, thereby generates charging information necessary for charging and payment, and accesses the application-provider server 40 designated by the application program.

The data storage unit 32 according to the present embodiment stores a plurality of executable files (apk files) of the application program which can be installed in the end-user terminal 60. Also, stored is the executable file (i.e. apk file) of the application program created and uploaded by the developer-user terminal 50. So, if the end-user terminal 60 accesses the application-provider server 40, it is possible to download the executable file (i.e. apk file) of any application program.

Configuration of Developer-User Terminal 50 and End-User Terminal 60

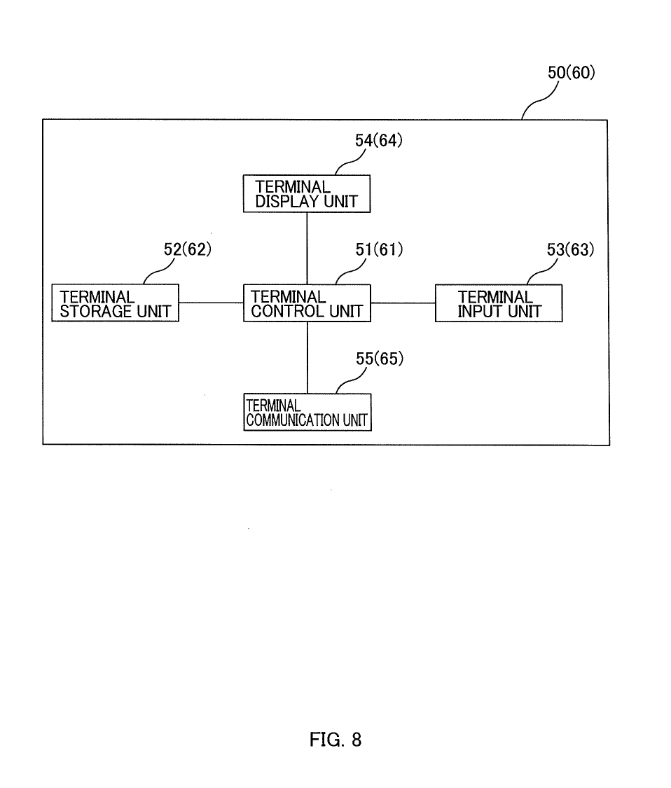

FIG. 8 is a block diagram showing a functional configuration of the developer-user terminal 50 and the end-user terminal 60.

The developer-user terminal 50 according to the present embodiment is an information processing device (i.e., a personal computer) used by a developer-user when creating application programs. The developer-user terminal 50 includes web browser software for interpreting XML-format files (XML data) and displaying them on screen. The web browser makes it possible to interpret XML data acquired from the application-creation support server 10, and to display Web pages (i.e. an operation screen) corresponding to the received XML data. The developer-user terminal 50 includes a terminal control unit 51, a terminal storage unit 52, a terminal input unit 53, a terminal display unit 54, and a terminal communication unit 55.

Further, the end-user terminal 60 according to the present embodiment is an information processing device (i.e., a mobile phone or a smartphone) used by an end user when playing a game. If an application program serving as a web browser is installed in the end-user terminal 60, the end-user terminal 60 can display a Web page (i.e. a game screen) associated with a game (i.e. a browser game). That is, starting such an application program causes the end-user terminal 60 to request the game server 20 to transmit a Web page (i.e. a game screen). The end-user terminal 60 receives a HTML file (including documents, images, audio data, etc.) transmitted by the game server 20 that responded to the request, and displays the Web page based on the description of the HTML file. The end-user terminal 60 includes a terminal control unit 61, a terminal storage unit 62, a terminal input unit 63, a terminal display unit 64, and a terminal communication unit 65.

The terminal control unit 51 and 61 are a unit that transfers data among the units and controls the entire user terminal, and is realized by a central processing unit (CPU) executing a program stored in a certain memory.

The terminal storage units 52 and 62 are respectively connected to the terminal control units 51 and 61 via bus. In accordance with commands from the terminal control units 51 and 61, the stored data is looked up, read, and rewritten. The terminal storage units 52 and 62 are realized, for example, by a flash memory, a hard disk and the like.

The terminal input unit 53 and 63 are a unit with which the user performs various operations, and is realized, for example, by an operating button, a touchscreen and the like.

The terminal display units 54 and 64 are for displaying operation screens or game screens according to commands from the respective terminal control units 51 and 61. The terminal display units 54 and 64 are realized, for example, by a liquid crystal display (LCD) and the like.

The terminal communication units 55 and 65 serve as a receiver-transmitter unit for transmitting and receiving various information via network between an external device such as the application-creation support server 10. The terminal communication units 55 and 65 are realized, for example, by a network interface card (NIC) and the like.

Operation Example of Application-Creation Support Server 10

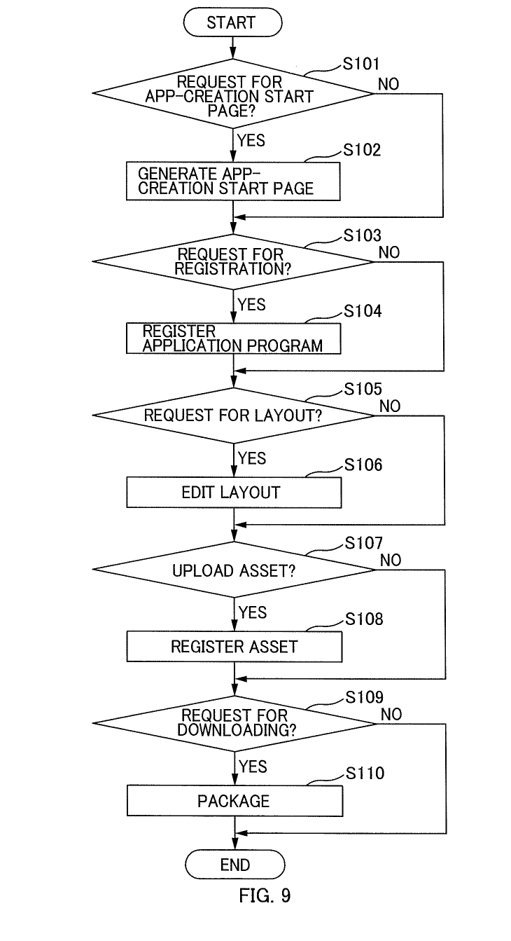

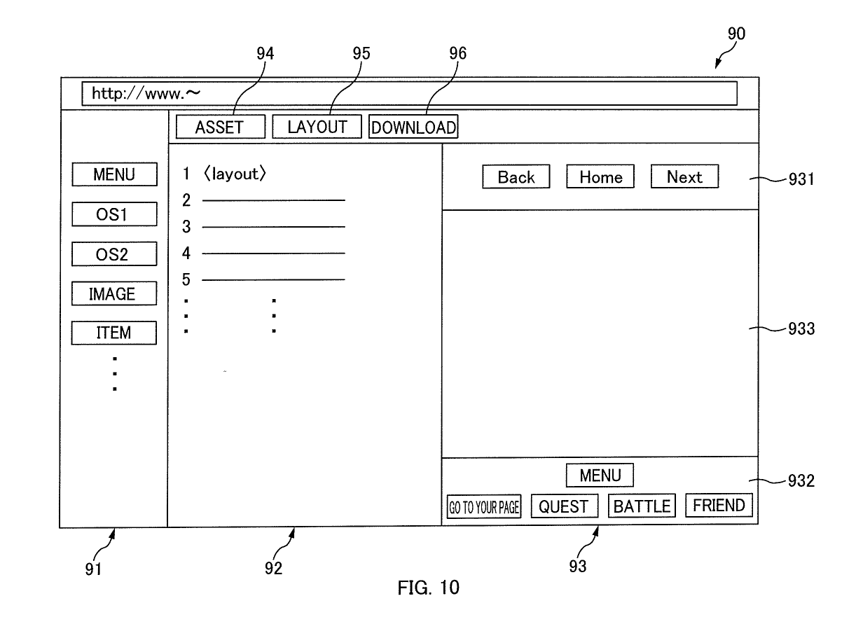

FIG. 9 is a flowchart illustrating an operation example of the application-creation support server 10 according to the present embodiment. An example of creating an application program (apk file) that runs on Android (R) OS will be described below. However, the invention is not limited thereto. For example, the invention can apply to cases of creating an application program (app files) that runs on iOS.

If the application-creation support server 10 receives from the developer-user terminal 50 a request for transmitting a Web page (application-creation start page) that is for creating an application program (S101: YES), the application-creation support server 10 causes the screen-data generation unit 116 to generate the screen data of the application-creation start page and transmits it to the developer-user terminal 50 which has issued the request (S102).

The developer-user terminal 50 displays the received application-creation start page on the web browser. The developer-user can select a link in the application-creation start page displayed on the web browser, and thereby he/she can move to another Web page.

Then, if the application-creation support server 10 receives from the developer-user terminal 50 a request for registering an application program newly created by the developer-user (S103: YES), the application-creation support server 10 causes the registration processing unit 111 to perform a process of registering the application program (S104).

In the present embodiment, while displaying a screen for registering a new application program on a web browser, a developer-user enters, in a predetermined form, registration information such as the application name, a user name, a game title, a game category, and the like. Then, the registration information entered by the developer-user is transmitted from the developer-user terminal 50 to the application-creation support server 10. The registration processing unit 111 correlates to a user ID the registration information transmitted from the developer-user terminal 50 and stores the information in the data storage unit 12 (see FIG. 3).

The application-generation unit 112 generates a new application program project (hereinafter referred to merely as a “project”) based on the registration information by using application-creation tools. Such a project is a set of application files composed of files and folders (directories) which are dealt with in a process of generating the application program. When the application-generation unit 112 generates a new project, the following folders and files constituting the project are stored in the project folder of the data storage unit 12: an assets folder; a drawable folder; a layout folder; a values folder; a manifest file; and the like. The assets folder is one in which assets such as image data and audio data are placed. The drawable folder is one in which image resources are placed; for example, the drawable folder contains icons of application programs. The layout folder is one in which XML files for defining screen layout of the application program are placed. The values folder is one in which XML files for defining character strings are placed. The manifest file is an XML file containing information necessary for causing the application program to run.

Further, the application-generation unit 112 gives to the newly-generated application program an application program ID (application ID) which is for identifying the application program. The generated project is correlated to the given application ID and stored in the data storage unit 12 as application information (see FIG. 4).

At this stage, the developer-user operates the developer-user terminal 50 and accesses a game server 20. The developer-user places, in the data storage unit 21 of the game server 20, an XML file (gadget.xml) of a browser game that runs in the application program. The XML file (gadget.xml) of the browser game contains the URL of the start page of the browser game. Then, the developer-user operates the developer-user terminal 50 and accesses the application-creation support server 10. The developer-user sets the URL of the start page to the generated application program project. The generated application program project always includes in its layout file a WebView for adding a function as a normal web browser. Therefore, designating the URL of the browser game using this WebView makes it possible to display on the application program a Web page transmitted from the designated site.

If the application-creation support server 10 receives from the developer-user terminal 50 a request for editing a screen layout of the newly generated application program (S105: YES), the application-creation support server 10 causes the layout processing unit 113 to perform a process of layout editing (S106). At this stage, the screen-data generation unit 116 generates screen data corresponding to a layout-editing screen (Web page) to be displayed on a web browser of the developer-user terminal 50. And, the screen-data generation unit 116 transmits the screen data to the developer-user terminal 50 which has issued the request.

FIG. 10 is a diagram showing an example of the appearance of a layout-editing screen 90 which is displayed on the web browser of the developer-user terminal 50. The layout-editing screen 90 includes: a menu region 91 for causing a developer-user to choose operations; a source code region 92 in which the source codes of files (XML files) constituting an application program project are displayed; a preview region 93 for testing the application program; an asset button 94 for registering assets (i.e. image data or audio data); a layout button 95 for displaying the layout-editing screen 90 on the web browser; and a download button 96 for downloading an executable file (apk file) made by building and converting the project.

In the menu region 91, included are a button for choosing an operating system (OS) and a button for settings related to items, for example. This allows developer-users to create an application program supporting an intended operating system (OS), or to set charging for users to access premium features and virtual goods. In the present embodiment, a developer-user chooses Android (R) OS by his/her operational input and creates an application program which runs on Android (R) OS.

In the source code region 92, displayed is the source code of the layout file (layout.xml) defining screen layout. This enables a developer-user to operate his/her developer-user terminal 50 and to edit the source code on a web browser. When the developer-user performs an editing operation, the operational information thereof is transmitted from the developer-user terminal 50 to the application-creation support server 10; thereby the layout file in the layout folder constituting the project is promptly changed. Note that, at the time of creating a new project, an original layout file (XML file) is stored in the layout folder, based on which the developer-user edits a layout.

In the preview region 93, operations of the application program which should carry out on the user terminal 60 are displayed on a virtual machine by the emulator unit 114. The preview region 93 includes: a header region 931 in which a “Home” button and the like are displayed; a game display region 933 for displaying a game screen; and a footer region 932 in which a “Menu” button and the like are displayed. For example, in the header region 931, displayed is rearrangement of the “Home” button caused by changing the source code. In the game display region 933, if the emulator unit 114 executes the application program (executable file), displayed is operations of the browser game provided by the game server 20 which is accessed based on the description of the application files. Thus, by operating the developer-user terminal 50, the developer-user edits the source code in the source code region 92 and tests in the preview region 93 the screen layout that has been edited. This makes it possible to efficiently edit a source code, which can speed up the development of application programs.

Going back to FIG. 9, if the application-creation support server 10 receives from the developer-user terminal 50 a request for registering assets constituting screen layout, (S107: YES), the application-creation support server 10 causes the registration processing unit 111 to perform a process of registering the assets (S108).

When the layout-editing screen 90 is displayed on the web browser of the developer-user terminal 50 as shown in FIG. 10, if the developer-user chooses the asset button 94, the developer-user can set assets (image data and audio data) constituting screen layout. For example, it is possible to set image data of various buttons displayed in the header region 931 or the footer region 932 (i.e. “Home” and “Menu”), or sound effect data that are heard when pushing these buttons. When the developer-user performs an operation for setting any asset, the asset (image data or audio data) is uploaded from the developer-user terminal 50 to the application-creation support server 10 and stored in the assets folder constituting the project. Note that, when creating a new project, the developer-user can edit layouts using image data, etc. stored in the assets folder as sample data.

If the application-creation support server 10 receives from the developer-user terminal 50 a request for downloading the package file (apk file) made by building the generated project (S109: YES), the application-creation support server 10 causes the packaging unit 115 to perform a packaging process (S110). The packaging process will be described in detail below.

Packaging Process

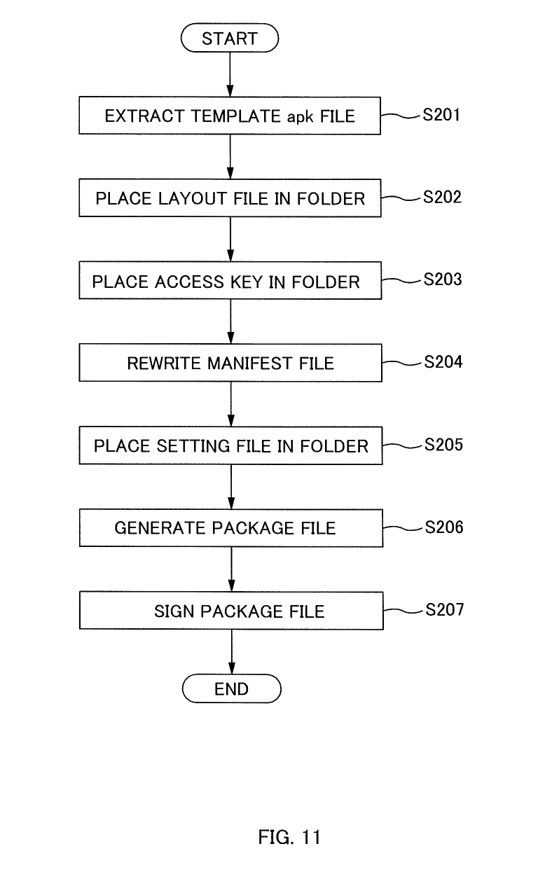

FIG. 11 is a flowchart illustrating the packaging process.

First, the packaging unit 115 extracts a template apk file acquired from the data storage unit 12 in order to create an application program which runs on Android (R) OS (S201).

The template apk file is a template of an executable file (apk file) packaged in a file format which can be installed in a user terminal 60. The template apk file contains a plurality of files necessary for causing the application program to run, and is compressed in ZIP format. By extracting the template apk file, the following folders and files constituting the template apk file are generated in the data storage unit 12: an assets folder; a drawable folder; a layout folder; a values folder; a manifest file; and the like. It should be noted that the template apk file contains charging-and-payment API that is necessary for charging and payment in the application program. Thus, when package file (apk file) is generated, the foregoing charging-and-payment API is also automatically packaged together. This can reduce users' operations for programming. It should be noted that the template apk file may include any API other than the charging-and-payment API; namely, a menu operation API for controlling menu operations during game play, an audio API for reproducing background music of the game, a utility API for acquiring the version, the screen size etc. of the game, a remote notification API for notification in the game, an inquiry API for providing an inquiry form in the game, an authentication API for user authentication, an invitation API for cooperating with an external SNS to invite friends, and the like.

A template of application programs, which is a shared content, is stored in the data storage unit 12 of the application-creation support server 10.

Subsequently, the packaging unit 115 retrieves, from the data storage unit 12 of the application-creation support server 10, a plurality of folders and files constituting a project generated at S104 in FIG. 9. And, the packaging unit 115 places them into the plurality of folders and files generated by extracting the template apk file (S202).

For example, an XML file defining a screen layout, which is placed in the layout folder constituting the project, is retrieved and placed into a layout folder generated by extracting the template apk file. And, image data and audio data constituting the screen layout, which is placed in the assets folder constituting the project, are retrieved and placed into the assets folder generated by extracting the template apk file.

Thereafter, the packaging unit 115 refers to user information shown in FIG. 3. Thereby the packaging unit 115 encrypts the access key assigned to a developer-user and places it into the plurality of files or folders generated by extracting the template apk file (S203).

Subsequently, the packaging unit 115 rewrites a manifest file generated by extracting the template apk file based on user information shown in FIG. 3 (S204). For example, in the manifest file, written are such types of information as an application name, a game title, a category or the like.

Next, the packaging unit 115 generates a setting file (config file), and places it into the plurality of folders and files generated by extracting the template apk file (S205). For example, as a setting file, generated are such types of information as an application ID, a country code where the application program is released, the URL of the intermediary server and the like.

Subsequently, after changing the plurality of folders and files constituting the template apk file from their initial states, the packaging unit 115 builds an executable file (apk file) of the application program which can be installed in a user terminal 60 (S206). By re-packaging the plurality of folders and files constituting the template apk file, a package file of the application program created by a developer-user is generated.

Subsequently, the packaging unit 115 signs, with a private key, a digital signature to the executable file (apk file) of the application program (S207). This makes it possible to certify that this application program is an authorized one.

As mentioned above, in the network system 1 according to the present embodiment, if a developer-user accesses the application-creation support server 10, he/she can easily create, edit, and test an application program on a web browser of his/her developer-user terminal 60. Also, if a developer-user accesses the application-creation support server 10, automatically packaged are a plurality of files and folders that is necessary for causing the application program to run and are edited by the developer-user, and then a package file (apk file) is generated. Thus, it is possible to easily make the application program of an existing browser game. Thus, the network system 1 according to the present embodiment makes it possible to cause developer-users to efficiently create application programs on a web browser.

The present embodiment facilitates understanding of the present invention and does not intend to limit the interpretation of the present invention. Variations and modifications may be made in accordance with the spirit and scope of the present invention and equivalents thereof are included in the present invention. In particular, embodiments described below are to be included in the present invention.

What is claimed is:

1. A network system comprising:
a service-provider server providing a browser service capable of running in a web browser;
a user terminal being used by a user when the user creates an application program on a web browser; and
an application-creation support server supporting the creation of the application program;
the service-provider server, the user terminal and the application-creation support server being communicably connected via network,
the application-creation support server including:
a storage unit that stores an application-creation tool used for the creation of the application program;
an application-generation unit that automatically generates an application file by using the application-creation tool and in response to a request from the user terminal,
the application file being for causing the browser service provided by the service-provider server to run in the application program;
a screen-data generation unit that generates screen data in response to a request from the user terminal,
the screen data being for displaying a layout-editing screen on a web browser of the user terminal which has issued the request,
the layout-editing screen including
a source code region in which a source code of a layout file included in the application file is displayed, and
a preview region for testing a screen layout defined by the layout file;
a layout processing unit that changes the layout file based on an editing operation input by the user on the layout-editing screen; and
a packaging unit that generates an executable file of the application program by using the application-creation tool and in response to a request from the user terminal, based on the generated application file, the executable file in which a plurality of files including the layout file that has been changed are packaged.

2. A network system according to claim 1, wherein
the network system further comprises an end-user terminal and an intermediary server that are communicably connected via network,
the end-user terminal being used by an end user,
the intermediary server being placed between the service-provider server and the end-user terminal,
when generating the application file, the application-generation unit gives to the application file identification information for identifying the application program,
the packaging unit causes the executable file of the application program to contain the identification information given to the application program,
the intermediary server includes a storage unit that stores a service-provider server list,
the service-provider server list containing a URL of the service-provider server correlating to the identification information given to the application program.

3. A network system according to claim 2, wherein
by installing the executable file of the application program that is generated by the packaging unit,
the end-user terminal
accesses the service-provider server through the intermediary server and
causes the browser service to run in the application program, and
when receiving an access request from the end-user terminal,
the intermediary server carries out an access control based on the service-provider server list.

4. A network system according to claim 1, wherein
the executable file of the application program contains a charging-and-payment API that is necessary for charging and payment in the application program.
